(19) United States
(12) Patent Application Publication
(10) Pub. No.: US 2024/0430029 A1
(43) Pub. Date: Dec. 26, 2024

(54) SELF-HEALING NETWORK TIMEKEEPING

(71) Applicant: Roblox Corporation, San Mateo, CA (US)

(72) Inventor: Braden CARTER, San Mateo, CA (US)

(73) Assignee: Roblox Corporation, San Mateo, CA (US)

(21) Appl. No.: 18/747,204

(22) Filed: Jun. 18, 2024

Related U.S. Application Data
(60) Provisional application No. 63/509,786, filed on Jun. 23, 2023.

(51) Int. Cl. H04J 3/06; H04L 7/00

(52) U.S. Cl. CPC H04J 3/0667; H04L 7/0054

(57) ABSTRACT

Implementations described herein relate to methods, systems, and computer-readable media for self-healing network timekeeping. A method can include monitoring a plurality of computing devices described in network topology data of a computer network, receiving asynchronous network configuration data from a computing device, the asynchronous network configuration data including at least one timekeeping value, determining that at least one timekeeping value exceeds a network timekeeping threshold, responsive to the determining, comparing a root of time in the asynchronous network configuration data with the network topology data to identify at least one network timekeeping configuration error, generating a list of actions to repair the network timekeeping configuration error, and directing the computing device to perform the list of actions.

### CROSS-REFERENCE TO RELATED APPLICATIONS

This application claims the benefit of priority to U.S. Provisional Application Ser. No. 63/509,786, filed on Jun. 23, 2023, entitled “SELF-HEALING NETWORK TIMEKEEPING,” the entire contents of which are hereby incorporated by reference herein.

### TECHNICAL FIELD

Embodiments relate generally to computer networks, and more particularly, to methods, systems, and computer readable media for self-healing network timekeeping.

### BACKGROUND

Network timekeeping generally includes the use of the network time protocol (NTP) to transmit time data from a source of time to a target server or computing device on a computer network. As devices and servers are constantly updated, refreshed, and/or rebooted, stored configurations for the source of time may be damaged or otherwise rendered invalid, thereby causing errors or fluctuations of time data across the computer network. Errors and fluctuations in time data can render many software applications, services, and micro-services inoperable. For example, any data exchanged on the computer network that is reliant on timed events may be affected by time data errors or time data fluctuations.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to an aspect, a computer-implemented method is provided.

Various implementations of the computer-implemented method are described.

According to another aspect, a system is described, comprising: a memory with instructions stored thereon; and a processing device, coupled to the memory and operable to access the memory, wherein the instructions, when executed by the processing device, cause the processing device to perform operations.

Various implementations of the system are described.

According to another aspect, a non-transitory computer-readable medium is described with instructions stored thereon that, responsive to execution by a processing device, causes the processing device to perform operations.

Various implementations of the non-transitory computer-readable medium are described.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF THE DRAWINGS

FIG. 1 is a diagram of an example network environment with self-healing network timekeeping, in accordance with some implementations.

FIG. 2 is a diagram of a multi-layer stratum with self-healing network timekeeping, in accordance with some implementations.

FIG. 3 is a flowchart illustrating an example method of self-healing network timekeeping, in accordance with some implementations.

FIG. 4 is a flowchart illustrating another example method of self-healing network timekeeping, in accordance with some implementations.

FIG. 5 is a diagram of an example virtual experience platform that can perform self-healing network timekeeping, in accordance with some implementations.

FIG. 6 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the content described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Online platforms offer a variety of ways for users to interact with one another, perform work and other activities, conduct research, and other tasks. Some online platforms offer software-as-a-service or productivity tools, while others may be directed towards online gaming or virtual experiences, and others still may be capable of performing many different tasks and provide many different data. The particular functions of each online platform may be performed by a plurality of computing devices and servers that are arranged according to a network topology and communicate data in relation to these functions. For example, users of an online platform may communicate, through a client device, to one or more computing devices, servers, and other network-connected devices to perform these tasks, access information, and/or other related activities.

Online platforms typically implement a timekeeping protocol, such as the Network Time Protocol (NTP), to ensure that the plurality of computing devices and servers providing services through the online platform maintain accurate and consistent time. For example, accurate time across all platform devices ensures that all services, micro-services, and communication packets are properly synchronized. Should time values at any particular device deviate from the actual time (or the time kept by other devices), significant abnormalities in functioning, as well as catastrophic faults, may become apparent.

Services provided by online platforms that do not keep accurate time often suffer from increased load/transmission times, transmission errors, login errors, database synchronization errors, data corruption, communication errors, and other similar drawbacks. Furthermore, the inaccurate time on one device can sometimes propagate to other devices, in a manner of “drift”, which may result in an entire system becoming inoperable or possibly unrecoverable through automatic or remote means. For example, if time errors are severe enough, remote assistance logins may malfunction thereby negating any remote effort to correct a device. Furthermore, in some circumstances, time errors may be duplicated across many devices on a platform such that those devices continue to operate with the incorrect time, while still throwing errors or faults in time-dependent tasks such as login, encryption/decryption, and other tasks.

Accordingly, while NTP provides a robust timekeeping protocol that oftentimes can result in stable systems, some online platforms may benefit from improved monitoring and healing of time errors that are currently not recoverable through conventional NTP implementations.

In accordance with aspects of this disclosure, a self-healing network timekeeping protocol is provided that builds upon NTP while ensuring that errors in time across an online platform are corrected prior to exceeding a threshold of inoperability of the platform. The self-healing network timekeeping protocol includes a new stratum that defines one or more network monitors configured to monitor and detect timekeeping errors in an automated manner.

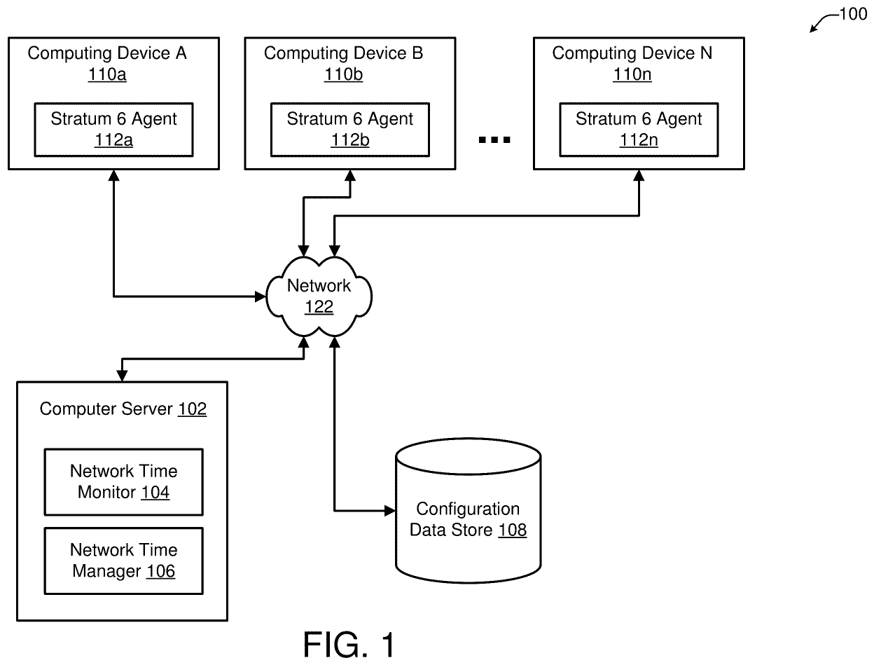

Hereinafter, an example networking environment for implementing self-healing network timekeeping in online platforms, software-as-a-service platforms, online gaming platforms, online virtual experience platforms, and other suitable alternatives is presented with reference to FIG. 1.

FIG. 1: Network Environment with Self-Healing Network Timekeeping

FIG. 1 illustrates an example network environment 100, in accordance with some implementations of the disclosure. FIG. 1 and the other figures use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

The network environment 100 (also referred to as a “system” and/or “online platform” herein) includes a computer server 102, a plurality of client devices 110 (110a, 110b, 110n), and a configuration data store 108, all connected via a network 122. The network 122 may communicate through any plurality of locales or other additional networks, providing for communication between the computing devices 110 and the computer server 102.

The computer server 102 can include, among other things, network time monitor 104 and network time manager 106. Each client device 110 can include a stratum 6 agent 112 (e.g., stratum 6 agent 112a, 112b, 112n, etc.). The depiction of exactly 6 strata is intended for illustration, and details may vary per implementation. Functionality and benefits of the proposed self-healing framework are the same, and equally applicable, with additional or fewer layers in the hierarchy.

Network environment 100 is provided for illustration. In some implementations, the network environment 100 may include the same, fewer, more, or different elements configured in the same or different manner as that shown in FIG. 1.

According to one implementation, the network environment 100 is organized with a multi-layer stratum hierarchy having one or more roots of time at a time source layer of the stratum, and where stratum 6 agents 112 are arranged at the sixth layer of the stratum. In this implementation, the fifth layer of the stratum is the lowest level of the hierarchy where timekeeping is consumed (e.g., useable for timekeeping of computing devices and servers). Accordingly, in some implementations, a six-layer stratum hierarchy is used where the sixth layer of the stratum is arranged to monitor time drift, time discrepancies, determine remedial actions, direct remedial actions, and/or other tasks as described herein.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the data store 108 is configured to store configuration data associated with the network environment 100. For example, the data store 108 may be arranged to store network topology data, time source data, time configuration data, and other timekeeping metrics and values that are useable to monitor health of the network environment 100.

In some implementations, the computer server 102 can include a server having one or more computing devices (e.g., a cloud computing system, a rackmount server, a server computer, cluster of physical servers, virtual server, etc.). In some implementations, a server may be included in the computer server 102, be an independent system, or be part of another system or platform.

In some implementations, the computer server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the computer server 102 and to provide self-healing timekeeping services on the network environment 100. The computer server 102 may also include a website (e.g., one or more webpages) or application back-end software that may be used to provide an administrator with access to configuration data (e.g., stored at data store 108) or other data and functionality.

In general, functions described as being performed by the computer server 102 can also be performed by the computing device(s) 110, or another server, in other implementations if appropriate. In addition, the functionality attributed to a particular component can be performed by different or multiple components operating together. The computer server 102 can also be accessed as a timekeeping service provided to other systems or devices through appropriate application programming interfaces (APIs), and thus is not limited to use as a standalone platform.

According to some implementations, the network time monitor 104 is a software service configured to execute at the computer server 102 and to direct the computer server 102 to perform a method of self-healing network timekeeping. The network time monitor 104 is configured to request network topology data from any computing device 110 and/or the configuration data store 108. Furthermore, the network time monitor 104 may be configured to receive an accurate time value from an accurate networked source of time.

According to some implementations, the network time monitor 104 is further or alternatively configured to continually poll one or more stratum 6 agents 112 as an NTP client, tracking common NTP data such as reference time source, root dispersion, jitter, reachability, variation from a broad range of combined sources, and stratum. Summaries of this data are then consumed by network time manager 106, to aggregate and compare data collected over time, analyze, fingerprint and detect variations or known defective configurations such as only using a local clock as a reference time source.

As used herein, an accurate time value refers to a time value that is within a predetermined amount of deviation from the value accepted to be actual real-world time. The predetermined amount of deviation may be chosen based upon standard network principles and may be different for different implementations of the techniques described herein. For example, for online services requiring sensitive time values the predetermined amount of deviation may be smaller than that employed by other online services that do not require sensitive time values.

The accurate time value may be received directly or indirectly from an accurate networked source of time, such as a time appliance. In some implementations, the time appliance may be at least one time appliance. In some implementations, the time appliance may be one of three separate time appliances organized and situated at a root level of the stratum hierarchy. The source of time may include a custom piece of hardware employing an atomic clock, in some implementations. The source of time may include a global-positioning system (GPS) with an antenna or antennae receiving time values from GPS satellites, in some implementations. In some implementations, several different types of sources of time and/or time appliances may be deployed simultaneously.

The network time monitor 104 may further be configured to monitor the plurality of computing device 110 as well as any other computing device described in the network topology data. For example, the network time monitor 104 may regularly receive asynchronous network configuration data from one or more of the computing devices 110 (or other computing devices). Thereafter, the network time monitor 104 may determine and identify one or more network timekeeping configuration errors.

For example, the network time monitor 104 may compare a root of time in the asynchronous network configuration data with the network topology data, as well as the accurate time value from the time appliance described above. If the root of time is incorrect, it may be indicative of a network timekeeping error. Similarly, if the root of time provided in the network configuration data doesn't properly match the network topology data, it may be indicative of a network timekeeping error. Moreover, if an actual time reported by the monitored computing device deviates from the accurate time value, it may be indicative of a network timekeeping error. Combined with additional topology data, errors can also indicate specific network errors independent of timekeeping.

Thus, the network time monitor 104 may monitor computing devices and compare asynchronous network configuration data reported therefrom to topology data from the data store 108. Errors determined or identified through the monitoring may be transmitted and/or communicated to the network time manager 106.

According to some implementations, the network time manager 106 is a software service configured to execute at the computer server 102 and to direct the computer server 102 to perform a method of self-healing network timekeeping. In some implementations, the network time manager 106 is configured to identify one or more likely causes of errors determined by the network time monitor 104. In some implementations, the network time manager 106 is also configured to identify the errors, as well as the cause of errors.

In some implementations, the network time manager 106 is configured to identify the one or more likely causes of errors based upon inspection of NTP data provided by the monitored computing devices and collected over time by network time monitor 104, the asynchronous network configuration data, and accurate network topology data. For example, the network topology data may be traversed to determine hop delays or other topology-dependent delays that may alter timekeeping values. Additionally, the typical NTP data may be inspected to derive a source of time used by the particular computing device. Furthermore, time source data may be inspected to determine if an errant source of time is used, if a default configuration or internal clock is being used, and/or other similar errors. It is noted that asynchronous network configuration data may be derived from additional NTP data sent by the computing device, or asynchronous network configuration data may be requested from the monitored computing devices directly by the network time monitor 104.

Other forms of derivation of possible source of time and timekeeping value errors may be possible using one or more of the stratum 6 agents 112, network time monitor 104, and network time manager 106. In some implementations, grouping time sources by ranges of average variability provides a critical insight for correlating problematic time sources or network sub-sections. Maintaining time-series trends allows for identifying patterns associated with other network events. Additionally, leveraging native NTP data for intermittently reachable time sources analyzed over different timespans and polling intervals provides another source of pattern detection for correlation, especially when combined with common network monitors for topology-change events (e.g., BGP updates, link flaps, etc.) or IP endpoint reachability via ICMP or TCP.

Depending upon the one or more likely causes identified by the network time manager 106, a list of actions to repair the identified errors may be generated by the network time manager 106. The list of actions may include commands and/or configuration changes that result in the remediation of the identified errors.

In some implementations, remedial actions may include any of the following: reconfiguration of timekeeping sources on stratum 6 agent 112, reconfiguration or restart of timekeeping software on stratum 6 agent 112 (or other timekeeping strata), reinstallation of timekeeping software on computing device 110, reboot of computing device 110, full reinstallation of all operating software and hardware firmware and/or configuration on computing device 110, or forced synchronization between timekeeping software and battery-backed hardware clock.

The list of actions may be directed to a repair service executing at the faulty computing device. For example, in some implementations, the stratum 6 agent 112 may be a repair service or microservice configured to input the list of actions, and to subsequently direct a faulty computing device 110 to perform one or more of the repair actions. In some implementations, a repair service may be transmitted as a “bot” or script having the list of actions embedded therein, to be deployed at the faulty computing device. In this manner, the list of actions may be performed automatically as described in the script or bot. In some implementations, the repair service may be deployed at one computing device, while the faulty computing device receives instructions (e.g., from the list of actions) from the one computing device.

In some implementations, network time manager 106 could publish changes to configuration datastore 108 or other configuration management framework, for computing device 110 to asynchronously apply periodically. In yet other implementations, stratum 6 agent 112 may be temporarily reconfigured to either accelerate or decelerate the computing device 110 system clock, so as to avoid instantaneous jumps forward or backward in time. Additionally, time-sensitive applications running on computing device 110 may temporarily be stopped or restarted, so as to avoid conflicts deriving from variability in networked or clustered environments.

As described above, a network time monitor 104 and a network time manager 106 operate within a network environment (e.g., 100) to monitor and automatically heal network timekeeping errors. Repairable errors may be identified automatically through comparison of network topology data retrieved from a centralized data store to asynchronous network configuration data provided by monitored computing devices. The repairable errors may include errors in a location of a time keeping appliance, errors in time values, errors in basic and/or default configuration data for the computing device, and other errors. In response to identification of the errors, a list of remedial actions may be generated that correct the errors, for example, by reconfiguring the computing device to use a desired or accurate source of time, to point to a correct timekeeping appliance, and other remedial actions.

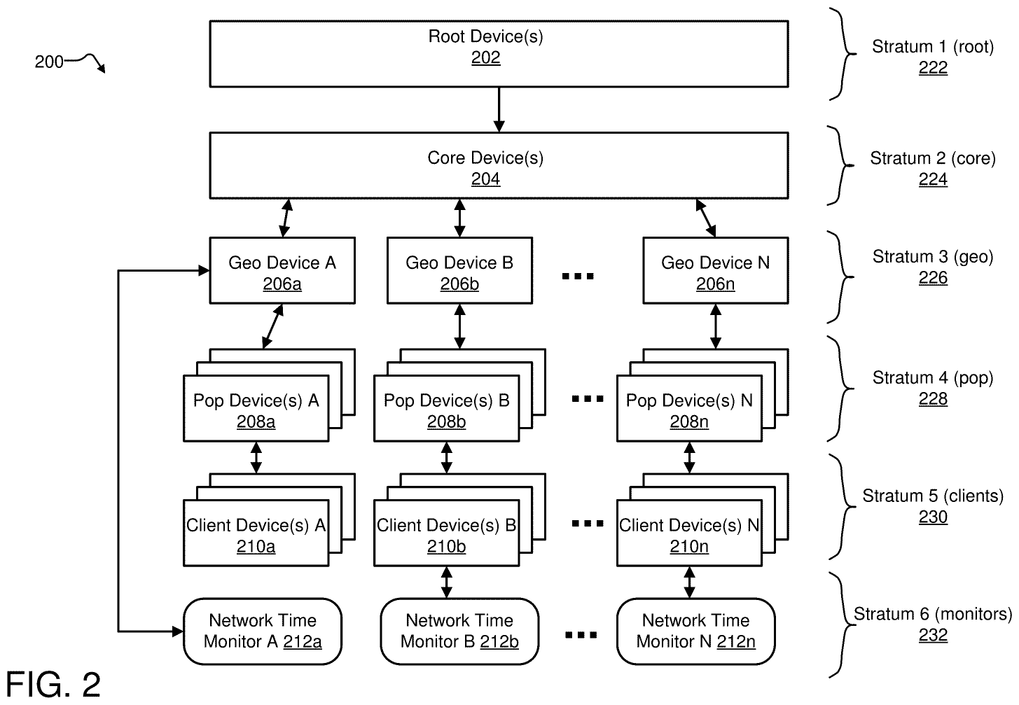

Hereinafter, an example stratum hierarchy useful for self-healing network timekeeping is presented with reference to FIG. 2.

FIG. 2: Stratum Hierarchy of Network Environment with Self-Healing Network Timekeeping

FIG. 2 is a diagram of a multi-layer stratum 200 with self-healing network timekeeping, in accordance with some implementations. As illustrated, the multi-layer stratum 200 includes six layers of stratum, beginning a root level 222 and ending at a sixth layer 232 of monitors.

The multi-layer stratum 200 includes a first root level 222 that includes one or more root device 202. The one or more root devices 202 may include three or more timekeeping appliances, in some implementations. In some implementations, the one or more root devices include one or more timekeeping appliances. Timekeeping appliances included in the root level 222 may include GPS-type appliances and/or atomic-clock-based appliances, in some implementations.

The multi-layer stratum 200 includes a second level 224 that includes one or more core devices 204. The core devices 204 receive time values directly from the root level 202 and associated timekeeping appliances. It is noted that the second level 224 is the only level in the multi-layer stratum 200 that include a direct connection to timekeeping appliances. The second level 224 provides for abstracting the root-of-time source of level 222, which allows testing, experimentation, and configuration changes independent of any configuration downstream (e.g., in the lower stratum layers described below).

The multi-layer stratum 200 includes a third level 226 that includes a plurality of geographically separated computing devices 206. The geographically separated devices 206 provide for scaling timekeeping services across vast geographical regions while still ensuring accurate and self-healing timekeeping services.

The multi-layer stratum 200 includes a fourth level 228 that includes a plurality of datacenters serving as regional “points-of-presence” (or “pops”) 208. The datacenters 208 may also provide for scaling timekeeping services across smaller distances (e.g., per geographical region based upon the previous level 226) while still ensuring accurate and self-healing timekeeping services.

The multi-layer stratum 200 includes a fifth level 230 that includes a plurality of leaf nodes (e.g., client devices 210). It is noted that the fifth level 230 is the lowest stratum level of the multi-layer stratum 200 where timekeeping is actually consumed by devices. Therefore, devices 210 may all receive network timekeeping services as described herein.

The multi-layer stratum 200 includes a sixth, final level, 232 that includes a plurality of network time monitors 212. It is noted that network time managers (e.g., 106) may also be deployed at the sixth level. Furthermore, stratum 6 agents 112 may also be deployed from devices at the sixth level 232 to devices at other levels. For example and as illustrated in FIG. 2, network time monitor 212a may monitor stratum 3 at level 226, while network time monitor 212b may monitor devices at other stratum levels. It is further noted that any monitor or manager deployed at the sixth level 232 may be operative to perform any of the methodologies described herein for monitoring, self-healing, remediation, and confirmation of timekeeping values.

As described above, a multi-layer stratum 200 is described that includes an extra stratum layer, the sixth or monitor-level layer, that is operative to perform some or all of the operations described herein related to monitoring and self-healing. Services deployed at the sixth level or sixth layer may receive asynchronous network configuration data, determine any errors in timekeeping values, and may determine a list of actions to correct the identified errors. Furthermore, stratum 6 repair agents may be deployed or directed to devices on any of the stratum layers 2-5 to direct said devices to perform one or more of the actions from the list of actions such that the identified errors are corrected.

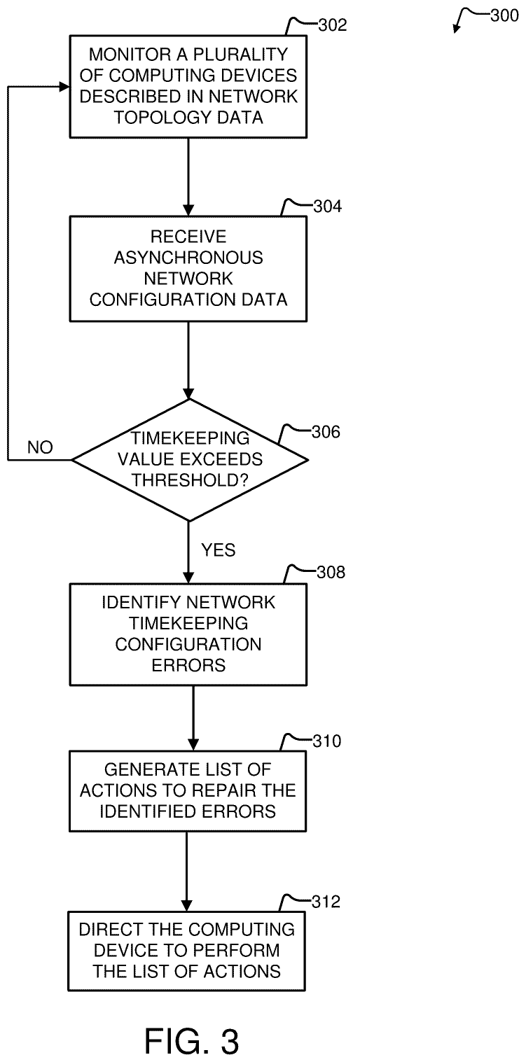

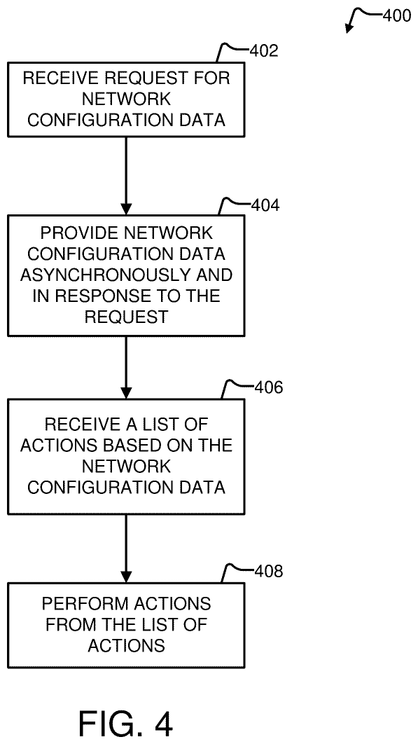

Hereinafter, methods of operation are described with reference to FIGS. 3 and 4.

### FIGS. 3-4: Methods of Self-Healing Network Timekeeping

FIG. 3 is a flowchart illustrating an example method 300 of self-healing network timekeeping, in accordance with some implementations.

In some implementations, method 300 can be implemented, for example, on a computer server. In some implementations, method 300 can be implemented, for example, on a computing device. In some implementations, method 300 may be implemented in a network environment such that multiple devices perform different portions of the method 300. In some implementations, some or all of the method 300 can be implemented on one or more computing devices, or on one or more server device(s), and/or on a combination of server device(s) and computing device(s). In described examples, the implementing system includes one or more digital processors or processing circuitry (“processors”), and one or more storage devices. In some implementations, different components of one or more computing devices and/or server devices can perform different blocks or other parts of the method 300.

The method 300 begins at block 302. Block 302 includes monitoring, with a network time monitor deployed at a computer server coupled to a computer network, a plurality of computing devices described in network topology data of the computer network. The monitoring may include monitoring NTP packets transmitted by one or more of the plurality of computing devices. The monitoring may also include monitoring a time value used by each of the computing devices.

In some implementations, the network topology data describes a multi-layer stratum hierarchy having one or more roots of time at a time source layer of the stratum, the computer device at a device layer of the stratum, and the network time monitor at a monitor layer of the stratum. Additionally, the device layer is lower in the stratum hierarchy than the time source layer and the monitor layer is lower in the stratum hierarchy than the device layer.

Furthermore, in some implementations, the multi-layer stratum hierarchy includes six layers. In these implementations, the network time monitor is at the sixth layer, and the second through fifth layers are device layers. Block 302 is followed by block 304.

Block 304 includes receiving, at the network time monitor, asynchronous network configuration data from a computing device of the plurality of computing devices. The asynchronous network configuration data includes at least one timekeeping value, such as a current time.

In some implementations, the asynchronous network configuration data includes asynchronous network timekeeping protocol (NTP) packets that each include a current time value and a source of time. In some implementations, asynchronous NTP packets may also include stratum data. In some implementations, the current time value and source of time are extracted from the NTP packets. In some implementations, the stratum data is extracted from the NTP packets. Additionally, in some implementations, the current time value is a time value received from the source of time at the computer device, and the source of time is either a local source of time or a networked source of time. Block 304 is followed by block 306.

Block 306 includes determining if the at least one timekeeping value exceeds a network timekeeping threshold. For example, the network time monitor or a network time manager may compare the timekeeping value to the accepted actual time. If the timekeeping value deviates from the actual time by a predetermined amount of time, there may be a timekeeping error. In some implementations, the network timekeeping threshold is between four and six minutes. In some implementations, the network timekeeping threshold is less than 1 second. In some implementations, the network timekeeping threshold is less than a fraction of a second.

In some implementations, other checks and/or decisions may be made by block 306 or alternative blocks (not illustrated). For example, errant sources of time, and other deviations, may also be used to establish thresholds and/or decisions in this and other methods. Block 306 is followed by block 308.

Block 308 includes, responsive to the determining, comparing a root of time described in the asynchronous network configuration data with the network topology data to identify at least one network timekeeping configuration error. In some implementations, the identified network timekeeping configuration error includes at least one of: an error in the local source of time or an error in the networked source of time. Furthermore, the identified network timekeeping configuration error can be indicated through use of internal time instead of network time. Moreover, discrepancies in the location of the source of time may also be indicative of timekeeping errors. Block 308 is followed by block 310.

Block 310 includes generating a list of actions to repair one or more network timekeeping configuration errors. In some implementations, the list of actions includes a list of computer-executable commands that, when executed at the computing device, cause the computing device to perform one or more of the list of actions. Block 310 is followed by block 312.

Block 312 includes directing the computing device to perform the list of actions. For example, directing the computing device may include transmitting, to a repair service, endpoint agent, stratum 6 agent 112, configuration data store 108, configuration framework or repository, or other service deployed at the computer server or at the computing device, the list of actions, where the repair service is configured to direct the computing device to perform at least one action within the list of actions. In some implementations, the performing may include executing one or more segments of computer-executable code to remediate the timekeeping error.

In some implementations, additional operations related to remediation and self-healing may be performed. For example, the method 300 can also include transmitting the list of actions, and confirming that the network timekeeping configuration errors are resolved. The confirming may be performed by one or more of the local endpoint repair service or agent, the network time monitor, and/or the network time manager.

In some implementations, the confirming may include receiving, at the network time monitor, new asynchronous network configuration data from the computing device. The confirming may also include determining that the new asynchronous network configuration data contains timekeeping values within the network timekeeping threshold. Other forms of confirmation may also be applicable, including testing viability of login sequences, testing platform stability, interrogating time-dependent applications or associated APIs for correct behavior, and other actions.

Other implementation features may also be applicable. For example, blocks 302-312 can be performed (or repeated) in a different order than described above and/or one or more steps can be omitted and/or combined into a single operation. Other changes may also be applicable.

FIG. 4 is a flowchart illustrating another example method 400 of self-healing network timekeeping, in accordance with some implementations.

In some implementations, method 400 can be implemented, for example, on a computer server. In some implementations, method 400 can be implemented, for example, on a computing device. In some implementations, method 400 may be implemented in a network environment such that multiple devices perform different portions of the method 400. In some implementations, some or all of the method 400 can be implemented on one or more computing devices, or on one or more server device(s), and/or on a combination of server device(s) and computing device(s). In described examples, the implementing system includes one or more digital processors or processing circuitry (“processors”), and one or more storage devices. In some implementations, different components of one or more computing devices and/or server devices can perform different blocks or other parts of the method 400.

The method 400 begins at block 402. Block 402 includes receiving a request for network configuration data. For example, the request may be received from a conventional NTP service executing in accordance with conventional timekeeping protocol. In another example, the request may be received from a network time monitor deployed as described herein. Block 402 may be followed by block 404. In some implementations block 402 may be omitted.

Block 404 includes providing the network configuration data asynchronously and/or in response to the request. In some implementations, the asynchronous network configuration data includes asynchronous network timekeeping protocol (NTP) packets that each include a current time value and a source of time. In some implementations, the current time value and source of time are extracted from the NTP packets. Additionally, in some implementations, the current time value is a time value received from the source of time at the computer device, and the source of time is either a local source of time or a networked source of time. Block 404 is followed by block 406.

Block 406 includes receiving a list of actions based on the transmitted network configuration data. For example, the list of actions may include remedial actions to correct an errant source of time, a timekeeping error, or other errors associated with accurate timekeeping across a computer network. Block 406 is followed by block 408.

Block 408 includes performing at least one action from the list of actions. For example, the list of actions may include computer commands, command-line commands, scripts, or other computer-executable code that, when implemented at the computing device, cause the computing device to correct and/or heal timekeeping errors.

Other implementation features may also be applicable. For example, blocks 402-408 can be performed (or repeated) in a different order than described above and/or one or more steps can be omitted and/or combined into a single operation. Other changes may also be applicable.

As described above, self-healing network timekeeping can be deployed at a plurality of different servers and computing devices associated with online platforms. In one example, a platform can be a virtual experience platform, which is described more fully below.

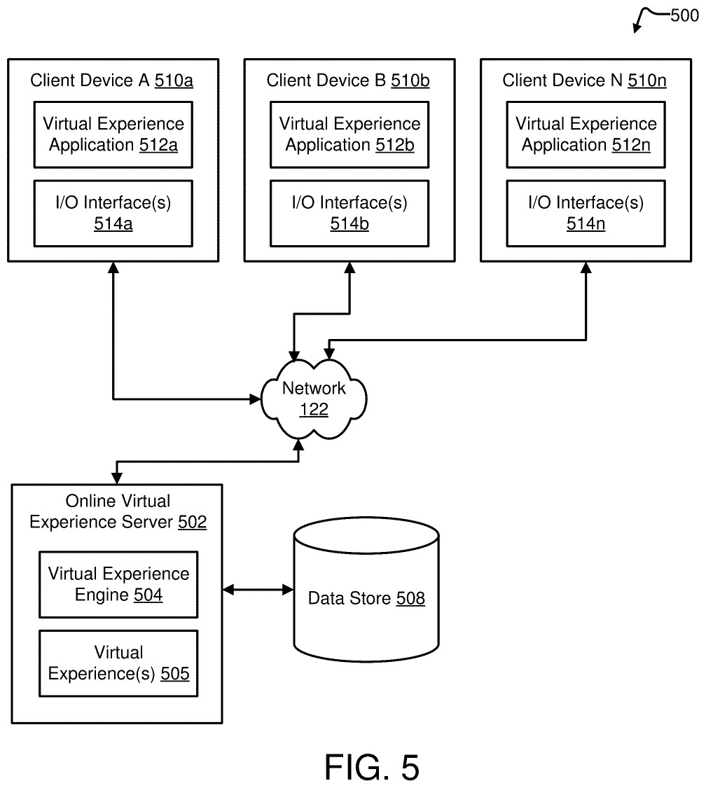

### FIG. 5: Example Use-Case in Virtual Experience Platform

FIG. 5 is a diagram of an example virtual experience platform 500 that can perform self-healing network timekeeping while also providing virtual experiences, in accordance with some implementations. The virtual experience platform 500 (also referred to as a “system” herein) includes an online virtual experience server 502, a data store 508, a client device 510 (or multiple client devices), all connected via a network 122.

The online virtual experience server 502 can include, among other things, a virtual experience engine 504, and one or more virtual experiences 505. The online virtual experience server 502 may be configured to provide virtual experiences to one or more client devices 510, in some implementations.

Data store 508 is shown coupled to online virtual experience server 502 but in some implementations, can also be provided as part of the online virtual experience server 502. The data store may, in some implementations, be configured to store advertising data, user data, engagement data, and/or other contextual data.

The client devices 510 (e.g., 510a, 510b, 510n) can include a virtual experience application 512 (e.g., 512a, 512b, 512n) and an I/O interface 514 (e.g., 514a, 514b, 514n), to interact with the online virtual experience server 502, and to view, for example, graphical user interfaces (GUI) through a computer monitor or display (not illustrated). In some implementations, the client devices 510 may be configured to execute and display virtual experiences, which may include virtual user engagement portal s as described herein.

Virtual experience platform 500 is provided for illustration. In some implementations, the virtual experience platform 500 may include the same, fewer, more, or different elements configured in the same or different manner as that shown in FIG. 5.

In some implementations, the data store 508 may be a non-transitory computer readable memory (e.g., random access memory), a cache, a drive (e.g., a hard drive), a flash drive, a database system, or another type of component or device capable of storing data. The data store 508 may also include multiple storage components (e.g., multiple drives or multiple databases) that may also span multiple computing devices (e.g., multiple server computers). In some implementations, clustered or hierarchical data stores may require strict timekeeping thresholds among members, for both functional and performance reasons. Furthermore, some implementations may cache data with time-based expiration or updates, requiring stringent accuracy.

In some implementations, the online virtual experience server 502 can include a server having one or more computing devices (e.g., a cloud computing system, a rackmount server, a server computer, cluster of physical servers, virtual server, etc.). In some implementations, a server may be included in the online virtual experience server 502, be an independent system, or be part of another system or platform. In some implementations, the online virtual experience server 502 may be a single server, or any combination of a plurality of servers, load balancers, network devices, and/or other components. The online virtual experience server 502 may also be implemented on physical servers, but may utilize virtualization technology, in some implementations. Other variations of the online virtual experience server 502 are also applicable.

In some implementations, the online virtual experience server 502 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 502 and to provide a user (e.g., user via client device 510) with access to online virtual experience server 502.

The online virtual experience server 502 may also include a website (e.g., one or more web pages) or application back-end software that may be used to provide a user with access to content provided by online virtual experience server 502. For example, users (or developers) may access online virtual experience server 502 using the virtual experience application 512 on client device 510, respectively.

In some implementations, online virtual experience server 502 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the virtual experience server 502.

In some implementations, online virtual experience server 502 or client device 510 may include the virtual experience engine 504 or virtual experience application 512. In some implementations, virtual experience engine 504 may be used for the development or execution of virtual experiences 505. For example, virtual experience engine 504 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 504 may generate commands that help compute and render the virtual experience (e.g., rendering commands, collision commands, physics commands, etc.).

The online virtual experience server 502 using virtual experience engine 504 may perform some or all the virtual experience engine functions (e.g., generate physics commands, rendering commands, etc.), or offload some or all the virtual experience engine functions to virtual experience engine 504 of client device 510 (not illustrated). In some implementations, each virtual experience 505 may have a different ratio between the virtual experience engine functions that are performed on the online virtual experience server 502 and the virtual experience engine functions that are performed on the client device 510.

In some implementations, virtual experience instructions may refer to instructions that allow a client device 510 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 510 may each include computing devices such as personal computers (PCs), mobile devices (e.g., laptops, mobile phones, smart phones, tablet computers, or netbook computers), network-connected televisions, gaming consoles, etc. In some implementations, a client device 510 may also be referred to as a “user device.” In some implementations, one or more client devices 510 may connect to the online virtual experience server 502 at any given moment. It may be noted that the number of client devices 510 is provided as illustration, rather than limitation. In some implementations, any number of client devices 510 may be used.

In some implementations, each client device 510 may include an instance of the virtual experience application 512. The virtual experience application 512 may be rendered for interaction at the client device 510. During user interaction within a virtual experience or another GUI of the online platform 500, a user may create an avatar that includes different body parts from different libraries, join different virtual experiences, and perform other activities.

In some implementations, the virtual experience platform 500 may include any of the features of FIG. 1, such that self-healing network timekeeping may be performed. Accordingly, in one implementation, a virtual experience platform includes a network time monitor and/or a network time agent deployed according to the stratum hierarchy of FIG. 2, to perform self-healing network timekeeping for the platform 500.

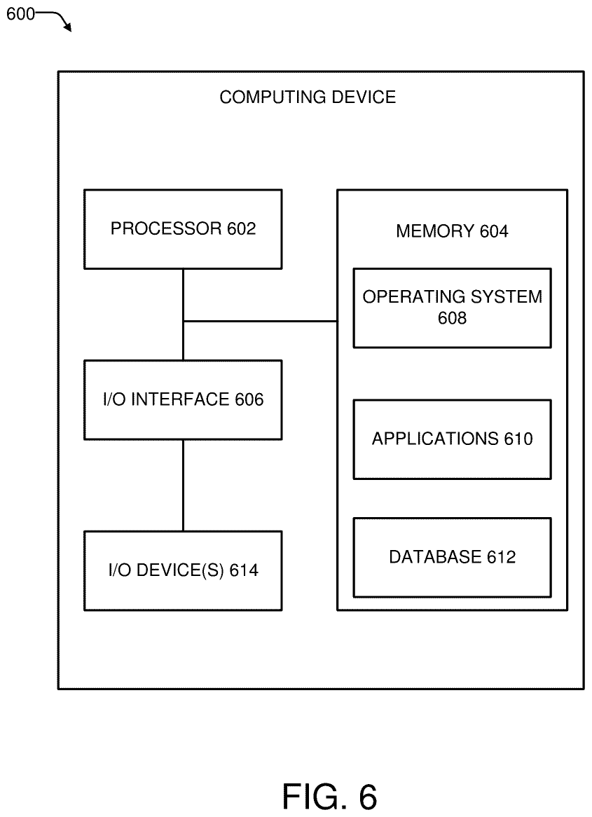

### FIG. 6: Example Computing Devices

Hereinafter, a more detailed description of various computing devices that may be used to implement different devices and/or components illustrated in FIGS. 1 and 5 is provided with reference to FIG. 6.

FIG. 6 is a block diagram of an example computing device 600 which may be used to implement one or more features described herein, in accordance with some implementations. In one example, device 600 may be used to implement a computer device, (e.g., 102, 110 of FIG. 1), and perform appropriate operations as described herein. Computing device 600 can be any suitable computer system, server, or other electronic or hardware device. For example, the computing device 600 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 600 includes a processor 602, a memory 604, input/output (I/O) interface 606, and audio/video input/output devices 614 (e.g., display screen, touchscreen, display goggles or glasses, audio speakers, headphones, microphone, etc.).

Processor 602 can be one or more processors and/or processing circuits to execute program code and control basic operations of the device 600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 608, software application 610 and associated data 612. In some implementations, the applications 610 can include instructions that enable processor 602 to perform the functions described herein. Software application 610 may include some or all of the functionality required to monitor and correct network timekeeping. In some implementations, one or more portions of software application 610 may be implemented in dedicated hardware such as an application-specific integrated circuit (ASIC), a programmable logic device (PLD), a field-programmable gate array (FPGA), a machine learning processor, etc. In some implementations, one or more portions of software application 610 may be implemented in general purpose processors, such as a central processing unit (CPU) or a graphics processing unit (GPU). In various implementations, suitable combinations of dedicated and/or general purpose processing hardware may be used to implement software application 610.

For example, software application 610 stored in memory 604 can include instructions for monitoring computing devices, determining networking timekeeping errors, and self-healing of the determined errors. Any of software in memory 604 can alternatively be stored on any other suitable storage location or computer-readable medium. In addition, memory 604 (and/or other connected storage device(s)) can store instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. For example, network communication devices, storage devices (e.g., memory and/or data store 508), and input/output devices can communicate via interface 606. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 6 shows one block for each of processor 602, memory 604, I/O interface 606, software blocks 608 and 610, and database 612. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While the online server 502 are described as performing operations as described in some implementations herein, any suitable component or combination of components of online server 502, or similar system, or any suitable processor or processors associated with such a system, may perform the operations described.

A user device can also implement and/or be used with features described herein. Example user devices can be computer devices including some similar components as the device 600, e.g., processor(s) 602, memory 604, and I/O interface 606. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 614, for example, can be connected to (or included in) the device 600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 300 and 400) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
monitoring, with a network time monitor deployed at a computer server coupled to a computer network, a plurality of computing devices described in network topology data of the computer network;
receiving, at the network time monitor, asynchronous network configuration data from a computing device of the plurality of computing devices, the asynchronous network configuration data including at least one timekeeping value;
determining that the at least one timekeeping value exceeds a network timekeeping threshold;
responsive to the determining, comparing a root of time in the asynchronous network configuration data with the network topology data to identify at least one network timekeeping configuration error;
generating a list of actions to repair the network timekeeping configuration error; and
directing the computing device to perform the list of actions.

2. The computer-implemented method of claim 1, further comprising:
after the directing, confirming that the network timekeeping configuration error is resolved.

3. The computer-implemented method of claim 1, wherein the network topology data describes a multi-layer stratum hierarchy having one or more roots of time at a time source layer of the stratum, the computer device at a device layer of the stratum, and the network time monitor at a monitor layer of the stratum, wherein the device layer is lower in the stratum hierarchy than the time source layer and the monitor layer is lower in the stratum hierarchy than the device layer.

4. The computer-implemented method of claim 3, wherein the multi-layer stratum hierarchy includes six layers, wherein the network time monitor is at the sixth layer, and wherein the second through fifth layers are device layers.

5. The computer-implemented method of claim 3, wherein the asynchronous network configuration data comprises asynchronous network timekeeping protocol (NTP) packets comprising:
a stratum value;
a current time value; and
a source of time.

6. The computer-implemented method of claim 5, wherein the current time value is a time value received from the source of time at the computer device, and wherein the source of time is either a local source of time or a networked source of time.

7. The computer-implemented method of claim 6, wherein the identified network timekeeping configuration error includes at least one of: an error in the local source of time or an error in the networked source of time.

8. The computer-implemented method of claim 1, wherein the network timekeeping threshold is a configurable time threshold.

9. The computer-implemented method of claim 1, wherein directing the computing device to perform the list of actions comprises:
transmitting, to a repair service deployed at the computer server or at the computing device, the list of actions, wherein the repair service is configured to direct the computer device to perform at least one action within the list of actions.

10. The computer-implemented method of claim 9, further comprising:
responsive to the transmitting, confirming that the network timekeeping configuration errors are resolved.

11. The computer-implemented method of claim 9, wherein confirming that the network timekeeping configuration errors are resolved comprises:
receiving, at the network time monitor, new asynchronous network configuration data from the computing device; and
determining that the new asynchronous network configuration data contains timekeeping values within the network timekeeping threshold.

12. A network timekeeping system for healing timekeeping errors on a computer network, comprising:
a memory with instructions stored thereon;
one or more processing devices, coupled to the memory, the one or more processing devices configured to access the memory and execute the instructions; and
one or more computer servers coupled to the one or more processing devices and configured to receive requests issued by a plurality of client devices, wherein the instructions cause the one or more processing devices to perform operations including:
monitoring, with a network time monitor deployed at a computer server coupled to a computer network, a plurality of computing devices described in network topology data of the computer network;
receiving, at the network time monitor, asynchronous network configuration data from a computing device of the plurality of computing devices, the asynchronous network configuration data including at least one timekeeping value;
determining that the at least one timekeeping value exceeds a network timekeeping threshold;
responsive to the determining, comparing a root of time in the asynchronous network configuration data with the network topology data to identify at least one network timekeeping configuration error;
generating a list of actions to repair the network timekeeping configuration error; and
directing the computing device to perform the list of actions.

13. The network timekeeping system of claim 12, further comprising a configuration database coupled to the one or more computer servers, wherein the configuration database is operable to maintain current network topology data for the computer network, and further comprising a manager service deployed at the computer server, wherein the manager service is configured to detect changes in network topology of the computer network based on the received network topology data, and wherein the operations further comprise responsive to the detected changes, iteratively monitoring, with the network time monitor, one or more computing devices described in the detected changes.

14. The network timekeeping system of claim 12, wherein the computer network comprises at least a three-layer stratum hierarchy having one or more roots of time at a first stratum, the computer device in another stratum, and the network time monitor at a lowest stratum of the at least three-layer stratum hierarchy.

15. The network timekeeping system of claim 14, wherein the one or more roots of time comprise at least one time appliance operatively coupled to the computer network.

16. The network timekeeping system of claim 15, wherein the asynchronous network configuration data comprises asynchronous network timekeeping protocol (NTP) packets comprising a stratum, a current time value, and a source of time, wherein the current time value is a time value received from the source of time at the computer device, and wherein the source of time is either a local source of time or a networked source of time.

17. The network timekeeping system of claim 15, wherein the identified network timekeeping configuration errors comprise at least an error in the local source of time or the networked source of time compared to time served from the at least one time appliance.

18. The network timekeeping system of claim 12, further comprising a repair service deployed at the computer server or the computing device, wherein the operations further comprise:
transmitting the list of actions to the repair service, wherein the repair service is configured to direct the computer device to perform at least one action within the list of actions.

19. The network timekeeping system of claim 12, further comprising a manager service deployed at the computer server, wherein the manager service is configured to detect changes in network topology of the computer network based on the received network topology data, and wherein the operations further comprise responsive to the detected changes, iteratively monitoring, with the network time monitor, one or more computing devices described in the detected changes.

20. A non-transitory computer-readable medium with instructions stored thereon that, responsive to execution by a processing device, causes the processing device to perform operations comprising:
monitoring, with a network time monitor deployed at a computer server coupled to a computer network, a plurality of computing devices described in network topology data of the computer network;
receiving, at the network time monitor, asynchronous network configuration data from a computing device of the plurality of computing devices, the asynchronous network configuration data including at least one timekeeping value;
determining that the at least one timekeeping value exceeds a network timekeeping threshold;
responsive to the determining, comparing a root of time in the asynchronous network configuration data with the network topology data to identify at least one network timekeeping configuration error;
generating a list of actions to repair the network timekeeping configuration error; and
directing the computing device to perform the list of actions.
